(19) United States
(12) Patent Application Publication
(10) Pub. No.: US 2026/0142231 A1
(43) Pub. Date: May 21, 2026

(54) SINGLE-ION CONDUCTING GEL POLYMER ELECTROLYTE AND METHOD FOR MANUFACTURING THE SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: JaeWook Shin, Hwaseong (KR); WonKeun Kim, Hwaseong (KR); Kyoung Han Ryu, Hwaseong (KR); Eunji Kwon, Hwaseong (KR); Jong-Chan Lee, Seoul (KR); Heewon Lee, Seoul (KR); Donggi Hong, Seoul (KR)

(21) Appl. No.: 19/208,217

(22) Filed: May 14, 2025

(30) Foreign Application Priority Data
Nov. 20, 2024 (KR) 10-2024-0166275

(51) Int. Cl. H01M 10/0565; H01M 10/0525

(52) U.S. Cl. CPC H01M 10/0565; H01M 10/0525; H01M 2300/0085

(57) ABSTRACT

A single-ion conducting gel polymer electrolyte includes a fluorine-based compound with 25-40% of its main chain converted to carbon double bonds, and 35-55 wt % of a lithium salt. The polymer ensures anion immobilization, thereby limiting conduction primarily to lithium ions. By including an optional additive such as PEGMEMA in specific weight ratios, the electrolyte achieves both high ionic conductivity and robust film formation. A method for preparing this gel polymer electrolyte involves mixing the fluorine-based compound, lithium salt, and a radical initiator, followed by in-situ crosslinking. The resulting free-standing film exhibits enhanced lithium-metal anode stability, suppressing dendrite formation. Also disclosed is a lithium secondary battery with this gel polymer electrolyte layer positioned between positive and negative electrodes, demonstrating improved cycle life and higher voltage stability disclosure.

### CROSS-REFERENCE TO RELATED APPLICATION

This application claims under 35 U.S.C. § 119 (a) the benefit of Korean Patent Application No. 10-2024-0166275 filed in the Korean Intellectual Property Office on Nov. 20, 2024, the entire contents of which are incorporated herein by reference.

### BACKGROUND

### Technical Field

The present disclosure relates to a single-ion conducting gel polymer electrolyte including a fluorine-based compound with an introduced carbon double bond.

### Background

As the electric vehicle market grows, demand is growing for high-capacity batteries that surpass conventional lithium-ion batteries, prompting a need for high-energy-density negative and positive electrode materials offering superior energy density and long-term stability.

As the battery market grows, it is necessary to apply lithium metal negative electrodes with a high theoretical capacity (3860 mAh g⁻¹) to replace graphite (372 mAh g⁻¹), which is a conventional negative electrode material, and high-voltage positive electrode materials are needed to increase battery energy density.

Additionally, dendrites that develop in lithium metal batteries can cause short circuits in the battery, posing a risk of fire. To address this, a single-ion conductor with a high lithium transference number may be used to suppress dendrite growth and achieve uniform lithium-ion deposition, or a lithium positive electrode protective layer may be introduced to form a stable SEI layer.

On the other hand, a study is conducted on using a polymer, which is obtained by copolymerizing poly(ethylene glycol) methacrylate (PEGMA) and LiMTFSI, as an electrolyte for an all-solid-state lithium metal battery. However, the polymer is effective only at low positive electrode capacity and current density (0.2 C-rate) due to the low lithium-ion conductivity (2.3×10⁻⁶ S cm⁻¹ at 25° C.) and has low high-voltage stability, making it difficult to apply the same to NCM positive electrode-based batteries.

Therefore, there is a need for a polymer electrolyte capable of providing higher ion conductivity while also enhancing high-voltage stability.

### SUMMARY

An embodiment of the present disclosure attempts to provide a gel polymer electrolyte with high single-ion conductivity and a method for manufacturing the same.

In addition, an embodiment of the present disclosure attempts to provide a gel polymer electrolyte and a method for manufacturing the same capable of suppressing dendrite growth that occurs when using a high-density electrolyte and a high-voltage positive electrode.

A gel polymer electrolyte according to an embodiment of the present disclosure is a single-ion conducting gel polymer electrolyte including a fluorine-based compound with a carbon double bond, and a lithium salt.

In aspects, the carbon double bond may be a carbon-carbon double bond. Other carbon double bonds also may be included, such as a carbon-nitrogen double bond.

In aspects, a carbon double bond may be introduced into the fluorine-based compound, e.g. the formed fluorine-based compound may be treated to introduce a carbon double bond. For instance, a fluorine polymer or oligomer may be modified in one or more synthetic steps to include or introduce a carbon double bond such as a carbon-carbon double bond.

The lithium salt may be included in an amount of 35 wt % to 55 wt % based on a total weight of the fluorine-based compound with an introduced carbon double bond and the lithium salt.

30% to 35% of a main chain of the fluorine-based compound with a carbon double bond may be a double bond.

The lithium salt may include one or more selected from the group consisting of lithium 1-(3-(methacryloyloxy) propylsulfonyl)-1-(trifluoromethanesulfonyl)imide (LiMTFSI), lithium (4-styrenesulfonyl) (trifluoromethanesulfonyl)imide (LiSTFSI), lithium methacrylic acid, and lithium 3-(2-methylprop-2-enoyloxy) propane-1-sulfonate.

The fluorine-based compound may be selected from the group consisting of polyvinylidene fluoride (PVDF), polyvinylidene fluoride-hexafluoropropylene (PVDF-HFP), polyvinylidene fluoride-co-chlorotrifluoroethylene (PVDF-CTFE), polyvinylidene fluoride-co-trifluoroethylene (PVDF-TrFE), polyvinylidene fluoride-co-trifluoroethylene-co-chlorofluoroethylene, polyvinylidene fluoride-co-hexafluoroethyelene, and polyvinylidene fluoride-co-hexafluoroethyelene.

The gel polymer electrolyte may further include an additive composed of poly(ethylene glycol)methyl ether methacrylate (PEGMEMA).

The additive may be included in an amount of 10 wt % to 40 wt % based on a total weight of the fluorine-based compound with a carbon double bond and the lithium salt.

The gel polymer electrolyte may further include an impregnated liquid electrolyte.

In an aspect, a method for manufacturing a gel polymer electrolyte is provide and may comprise a) preparing mixture by mixing a fluorine-based compound with a carbon double bond, a lithium salt, and a radical initiator; and b) applying the mixture to a base material, and thereafter c) crosslinking the mixture. In preferred aspects, the lithium salt is added in an amount of about 35 wt % to 55 wt % based on a total weight of the fluorine-based compound, the lithium salt, and a crosslinking agent. In referred aspects, the mixture may be cross-linked in-situ after applying the mixture to the base material.

In a further aspect, a method for manufacturing a gel polymer electrolyte of the present disclosure may include: preparing a mixture by mixing a fluorine-based compound with a carbon double bond, a lithium salt, and a radical initiator; and applying the mixture to a base material, followed by an in-situ crosslinking reaction.

The lithium salt may be added in an amount of 35 wt % to 55 wt % based on a total weight of the fluorine-based compound, the lithium salt, and a crosslinking agent.

In certain aspects, the fluorine-based compound with a carbon double bond may be obtained by mixing a fluorine-based compound and a basic substance to form a fluorine-based compound with an introduced carbon double bond.

The basic substance may be one or more selected from the group consisting of ethylenediamine (EDA), isopropylethylenediamine (IEDA), 1,3 phenylenediamine (PDA), 1,5-naphthalenediamine (NDA), 2,4,4-trimethyl-1 or 6-hexanediamine (THDA), dicumyl peroxide (DCP), benzoyl peroxide, bisphenol A, and methylenediamine.

The fluorine-based compound may be one or more selected from the group consisting of polyvinylidene fluoride (PVDF), polyvinylchloride (PVC), polymethyl methacrylate (PMMA), polyacrylonitrile (PAN), and polyvinylidene fluoride-hexafluoropropylene (PVDF-HFP).

The mixing the fluorine-based compound and the basic substance to form a fluorine-based compound with an introduced carbon double bond may involve stirring the fluorine-based compound and the basic substance at a room temperature for 60 to 100 hours.

The lithium salt may include one or more selected from the group consisting of lithium 1-(3-(methacryloyloxy) propylsulfonyl)-1-(trifluoromethanesulfonyl)imide (LiMTFSI), lithium (4-styrenesulfonyl) (trifluoromethanesulfonyl)imide (LiSTFSI), lithium methacrylic acid, and lithium 3-(2-methylprop-2-enoyloxy) propane-1-sulfonate.

In the preparing the mixture by mixing the fluorine-based compound with an introduced carbon double bond, the lithium salt, and the radical initiator, an additive composed of poly(ethylene glycol)methyl ether methacrylate (PEGMEMA) may be further mixed.

The additive may be mixed in an amount of 10 wt % to 40 wt % based on a total weight of the fluorine-based compound with an introduced carbon double bond and the lithium salt.

Another embodiment of the present disclosure may be a lithium secondary battery including: a positive electrode layer; a negative electrode layer; and an electrolyte layer positioned between the positive electrode layer and the negative electrode layer, in which the electrolyte layer includes a gel polymer electrolyte layer, and the gel polymer electrolyte layer includes the gel polymer electrolyte described above.

The gel polymer electrolyte according to an embodiment of the present disclosure has an advantage of high single-ion conductivity.

The method for manufacturing a gel polymer electrolyte according to another embodiment of the present disclosure has an advantage of enabling the manufacture of a gel polymer electrolyte with high single-ion conductivity.

In some embodiments, a gel polymer electrolyte being a single-ion conducting gel polymer electrolyte includes a fluorine-based compound with an introduced carbon double bond selected from the group consisting of polyvinylidene fluoride (PVDF), polyvinylidene fluoride-hexafluoropropylene (PVDF-HFP), polyvinylidene fluoride-co-chlorotrifluoroethylene (PVDF-CTFE), polyvinylidene fluoride-co-trifluoroethylene (PVDF-TrFE), polyvinylidene fluoride-co-trifluoroethylene-co-chlorofluoroethylene, polyvinylidene fluoride-co-hexafluoroethyelene, polyvinylidene fluoride-co-hexafluoroethyelene, and a combination thereof; and a lithium salt selected from the group consisting of lithium 1-(3-(methacryloyloxy) propylsulfonyl)-1-(trifluoromethanesulfonyl)imide (LiMTFSI), lithium (4-styrenesulfonyl) (trifluoromethanesulfonyl)imide (LiSTFSI), lithium methacrylic acid, and lithium 3-(2-methylprop-2-enoyloxy) propane-1-sulfonate, and a combination thereof. About 25% to 40% of a main chain of the fluorine-based compound with an introduced carbon double bond is a double bond, and the lithium salt is present in an amount of about 35 wt % to about 55 wt % based on a total weight of the fluorine-based compound and the lithium salt.

The gel polymer electrolyte may further comprise an additive composed of poly(ethylene glycol)methyl ether methacrylate (PEGMEMA). The additive may be included in an amount of about 10 wt % to 40 wt % based on a total weight of the fluorine-based compound and the lithium salt.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 is a schematic diagram of a method for manufacturing a gel polymer electrolyte according to an embodiment of the present disclosure.

FIG. 2 is a cross-sectional view schematically showing a positive electrode layer, an electrolyte layer, and a negative electrode layer of a lithium secondary battery.

FIG. 3 shows an IR analysis result of EDA-PVdF prepared according to Preparation Example 1.

FIG. 4 shows an XPS analysis result of EDA-PVdF prepared according to Preparation Example 1.

FIG. 5 shows lithium-ion conductivity analysis results of gel polymer electrolytes prepared according to Comparative Examples and Examples.

FIG. 6(a) is a photograph of a gel polymer electrolyte according to Example 2, and FIG. 6(b) shows a result of a crosslinking test.

FIG. 7 is a photograph showing that a gel polymer electrolyte according to Comparative Example 3 is not separated from a substrate.

FIG. 8 shows high-voltage stability measurement results at 4.55 V for a lithium metal battery of a Comparative Example and a lithium metal battery of an Example.

FIG. 9 shows cycle life characteristic analysis results for a lithium metal battery of a Comparative Example and a lithium metal battery of an Example.

### DETAILED DESCRIPTION OF THE EMBODIMENTS

The terms such as first, second and third are used for describing, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present disclosure.

The technical terms used herein are set forth only to mention specific embodiments and are not intended to limit the present disclosure. Singular forms used herein are intended to include the plural forms as long as phrases do not clearly indicate an opposite meaning. In the present specification, the term “including (comprising)” is intended to embody specific characteristics, regions, integers, steps, operations, elements and/or components, but is not intended to exclude presence or addition of other characteristics, regions, integers, steps, operations, elements, and/or components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

When a part is referred to as being “above” or “on” another part, it may be directly above or on the other part or an intervening part may also be present. In contrast, when a part is referred to as being “directly above” another part, there is no intervening part present. Unless otherwise defined, all terms including technical and scientific terms used herein have the same meanings as the meanings generally understood by one skilled in the art to which the present disclosure pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

In the present specification, the term “combination(s) thereof” included in the expression of the Markush format means one or more mixtures or combinations selected from the group consisting of the constituent elements described in the expression of the Markush format, and means including one or more selected from the group consisting of the constituent elements.

Hereinafter, embodiments of the present disclosure will be described in detail so that one skilled in the art to which the present disclosure pertains can easily implement the present disclosure. As those skilled in the art would realize, the described embodiments may be modified in various different ways, all without departing from the spirit or scope of the present disclosure.

### <Gel Polymer Electrolyte>

A gel polymer electrolyte according to an embodiment of the present disclosure may include a fluorine-based compound with a carbon double bond and a lithium salt.

In an embodiment of the present disclosure, the lithium salt may be included in an amount of 35 wt % to 55 wt %, specifically, 40 to 55 wt %, or 45 to 55 wt % based on a total weight of the fluorine-based compound with an introduced carbon double bond and the lithium salt. Including the lithium salt within the above range is preferable because it provides high conductivity for lithium ions and enhances stability at high voltages, enabling excellent cycle life when applied to lithium secondary batteries. If the content of lithium salt falls below the above range, it is difficult to obtain the desired ion conductivity. If the content of lithium salt exceeds the above range, it is difficult to separate a gel polymer electrolyte from a substrate during the manufacturing process of the gel polymer electrolyte, leading to quality degradation.

The fluorine-based compound may be selected from the group consisting of polyvinylidene fluoride (PVDF), polyvinylidene fluoride-hexafluoropropylene (PVDF-HFP), polyvinylidene fluoride-co-chlorotrifluoroethylene (PVDF-CTFE), polyvinylidene fluoride-co-trifluoroethylene (PVDF-TrFE), polyvinylidene fluoride-co-trifluoroethylene-co-chlorofluoroethylene, polyvinylidene fluoride-co-hexafluoroethyelene, and polyvinylidene fluoride-co-hexafluoroethyelene.

25% to 40%, specifically 30% to 35%, of a main chain of the fluorine-based compound with a carbon double bond may be a double bond. When the carbon double bond (C═C), as analyzed by XPS, falls within the above range, anions are included in the polymer main chain, allowing only lithium ions to migrate, and dendrite growth due to uneven lithium-ion deposition caused by anion migration on the surface of the lithium metal negative electrode can be suppressed, which is preferable.

The lithium salt may contain lithium cations and anions. The use of the lithium salt can suppress polarization of the battery and lithium dendrite growth.

The lithium salt may include one or more selected from the group consisting of lithium 1-(3-(methacryloyloxy) propylsulfonyl)-1-(trifluoromethanesulfonyl)imide (LiMTFSI), lithium (4-styrenesulfonyl) (trifluoromethanesulfonyl)imide (LiSTFSI), lithium methacrylic acid, and lithium 3-(2-methylprop-2-enoyloxy) propane-1-sulfonate.

The gel polymer electrolyte may further include an additive composed of poly(ethylene glycol)methyl ether methacrylate (PEGMEMA). This offers the advantages of increasing the crosslinking density and lowering the glass transition temperature of the polymer, facilitating lithium transport and providing additional ion conductivity.

In an embodiment of the present disclosure, the additive may be included in an amount of 10 wt % to 40 wt % based on a total weight of the fluorine-based compound with a carbon double bond and the lithium salt.

In an embodiment of the present disclosure, the gel polymer electrolyte may further include an impregnated liquid electrolyte.

The liquid electrolyte may include one or more selected from the group consisting of ethylene carbonate, dimethyl carbonate, diethyl carbonate, ethyl methyl carbonate, fluoroethylene carbonate, 1,2-dimethoxy ethane, 1,2-diethoxy ethane, dimethylene glycol dimethyl ether, trimethylene glycol dimethyl ether, triethylene glycol dimethyl ether, tetraethylene glycol dimethyl ether, polyethylene glycol dimethyl ether, succinonitrile, sulfolane, dimethyl sulfone, ethyl methyl sulfone, diethyl sulfone, adiponitrile, 1,1,2,2-tetrafluoroethyl 2,2,3,3-tetrafluoropropyl ether, and dimethylacetamide.

The liquid electrolyte may further include a lithium salt, and the lithium salt included in the liquid electrolyte may include one or more selected from the group consisting of LiNO₃, LiPF₆, LiBF₆, LiClO₄, LiCF₃SO₃, LiBr, and LiI.

### <Method for Manufacturing Gel Polymer Electrolyte>

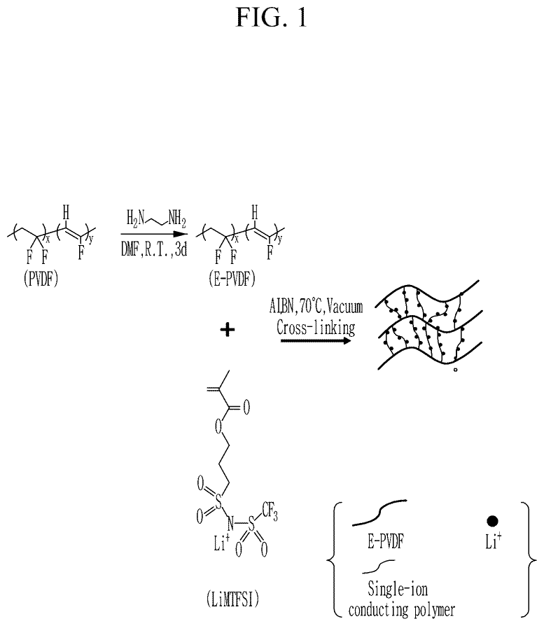

FIG. 1 is a schematic diagram of a method for manufacturing a gel polymer electrolyte according to an embodiment of the present disclosure.

Below, a method for manufacturing a gel polymer electrolyte according to an embodiment of the present disclosure will be specifically described with reference to FIG. 1.

Referring to FIG. 1, a method for manufacturing a gel polymer electrolyte according to an embodiment of the present disclosure may include steps of preparing a mixture by mixing a fluorine-based compound with a carbon double bond, a lithium salt, and a radical initiator; and applying the mixture to a base material, followed by an in-situ crosslinking reaction.

The fluorine-based compound with a carbon double bond may be formed by treating a fluorine-based compound with a base, and specifically, may be obtained through a step of mixing a fluorine-based compound and a basic substance to form a fluorine-based compound with an introduced carbon double bond.

In the step of mixing a fluorine-based compound and a basic substance to form a fluorine-based compound with a carbon double bond, ethylenediamine (EDA), which has a relatively low pKa value, was used.

Specifically, EDA corresponding to 45 to 55% mole ratio of the repeating units of the fluorine-based compound was used. If the above mole ratio range is exceeded, purification becomes impossible due to crosslinking caused by a dehydrofluorination reaction between chains of the fluorine-based compound chains. In addition, if the mole ratio falls below the above range, carbon double bonds are not effectively introduced.

The fluorine-based compound and the basic substance may be mixed and stirred at a room temperature for 60 hours or longer, specifically, for 60 to 100 hours, 60 to 80 hours, or 65 to 75 hours.

The fluorine-based compound may be one or more selected from the group consisting of polyvinylidene fluoride (PVDF), polyvinylchloride (PVC), polymethyl methacrylate (PMMA), polyacrylonitrile (PAN), and polyvinylidene fluoride-hexafluoropropylene (PVDF-HFP), and specifically, may be polyvinylidene fluoride (PVDF).

The basic substance may be one or more selected from the group consisting of ethylenediamine (EDA), isopropylethylenediamine (IEDA), 1,3 phenylenediamine (PDA), 1,5-naphthalenediamine (NDA), 2,4,4-trimethyl-1 or 6-hexanediamine (THDA), dicumyl peroxide (DCP), benzoyl peroxide, bisphenol A, and methylenediamine, and specifically, may be ethylenediamine (EDA).

The lithium salt may include one or more selected from the group consisting of lithium 1-(3-(methacryloyloxy) propylsulfonyl)-1-(trifluoromethanesulfonyl)imide (LiMTFSI) and lithium (4-styrenesulfonyl) (trifluoromethanesulfonyl)imide (LiSTFSI).

The initiator may include one or more selected from the group consisting of azobis(isobutyronitrile) (AIBN), benzoyl peroxide, acetyl peroxide, dilauryl peroxide, di-tert-butylperoxide, t-butyl peroxy-2-ethyl-hexanoate, cumyl hydroperoxide, hydrogen peroxide, 2,2-azobis(2-cyanobutane) [2,2-azobis(methylbutyronitrile)], and azobisdimethylvaleronitrile (AMVN), and specifically, may be azobis(isobutyronitrile) (AIBN).

Note that in the step of preparing the mixture by mixing the fluorine-based compound with an introduced carbon double bond, the lithium salt, and the radical initiator, an additive composed of poly(ethylene glycol)methyl ether methacrylate (PEGMEMA) may be further mixed.

The additive may be mixed in an amount of 10 wt % to 40 wt % based on a total weight of the fluorine-based compound with an introduced carbon double bond and the lithium salt.

When the additive is mixed within the above range, a high-quality polymer gel electrolyte can be manufactured. If the additive exceeds the above range, it is difficult to form a self-standing polymer gel electrolyte, and if the additive falls below the above range, the quality of the manufactured polymer gel electrolyte degrades.

### <Lithium Secondary Battery>

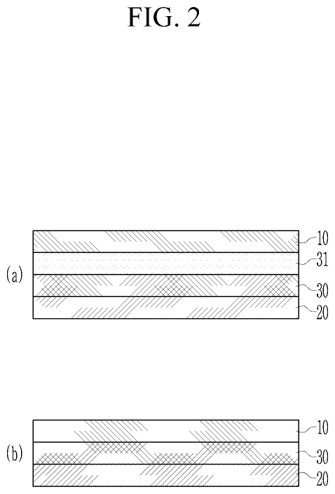

FIG. 2 is a cross-sectional view schematically showing a positive electrode layer, an electrolyte layer, and a negative electrode layer of a lithium secondary battery.

Referring to FIG. 2(a), a lithium secondary battery according to an embodiment of the present disclosure may include a positive electrode layer 20, a negative electrode layer 10, and an electrolyte layer 30 positioned between the positive electrode layer and the negative electrode layer. The electrolyte layer 30 may include the aforementioned gel polymer electrolyte layer 31, and the gel polymer electrolyte layer 31 may include a gel polymer electrolyte. Since the gel polymer electrolyte has been described in detail above, it is omitted here.

Note that the gel polymer electrolyte may be positioned in the form of a thin film between the negative electrode layer and the electrolyte layer, and specifically, may be in the form of a thin film having a thickness ranging from 30 μm to 40 μm. If the thickness of the gel polymer electrolyte exceeds the above range, the initial discharge capacity decreases, and if the thickness falls below the above range, damage to the intermediate layer occurs during the separation process from the substrate.

Note that the positive electrode layer of the lithium secondary battery according to an embodiment of the present disclosure may contain a positive electrode active material for which a charging voltage within a range of 4.3 V or less is used.

Below, preferred Examples of the present disclosure and Comparative Examples will be described. However, the following Examples are only preferred examples of the present disclosure, and the present disclosure is not limited to the following Examples.

### (Preparation Example 1) Preparation of Fluorine-Based Compound with Introduced Carbon Double Bond

3 g of polyvinylidene fluoride (PVDF) and 2.8 g of ethylenediamine (EDA) were dispersed by sonication in 30 mL of dimethylformamide (DMF) as a solvent and stirred at room temperature (approximately 25° C.) for about 72 hours, followed by precipitation in ethanol and filtration to prepare EDA-PVdF.

The prepared EDA-PVdF, lithium 1-(3-(methacryloyloxy) propylsulfonyl)-1-(trifluoromethanesulfonyl)imide (LiMTFSI) as a lithium salt, and azobis(isobutyronitrile) (AIBN) as an initiator were added. Subsequently, they were dispersed by sonication for about 3 hours and cast on a glass plate. The resulting product was subjected to in-situ crosslinking at about 70° C. for 18 hours under vacuum conditions to obtain a gel polymer electrolyte. The gel polymer electrolyte was washed with ethanol to remove unreacted lithium salt.

### (Examples and Comparative Examples) Preparation of Gel Polymer Electrolyte

The EDA-PVdF prepared according to the preparation example, lithium 1-(3-(methacryloyloxy) propylsulfonyl)-1-(trifluoromethanesulfonyl)imide (LiMTFSI) as a lithium salt, and azobis(isobutyronitrile) (AIBN) as an initiator were added. Subsequently, they were dispersed by sonication for about 3 hours and cast on a glass plate. The resulting product was subjected to in-situ crosslinking at about 70° C. under vacuum conditions to obtain a gel polymer electrolyte. The gel polymer electrolyte was washed with ethanol to remove unreacted lithium salt.

The weight contents of EDA-PVdF and lithium salt LiMTFSI according to the examples and comparative examples are shown in Table 1 below.

### Evaluation Example 1: IR Analysis

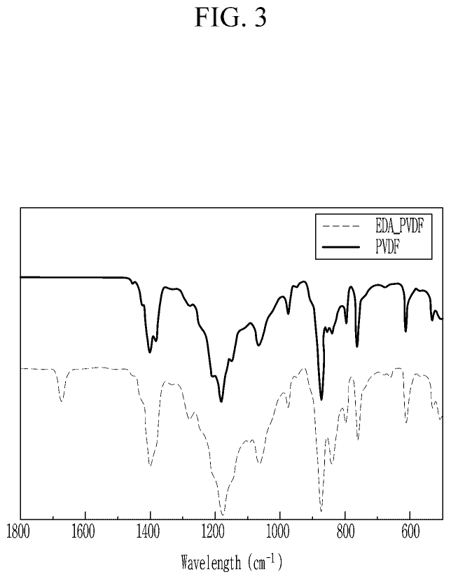

IR analysis was performed on EDA-PVdF prepared according to Preparation Example 1, and the analysis results are shown in FIG. 3.

Referring to FIG. 3, the C═C bond signal at a wavelength of 1650 cm⁻¹ confirms that the double bond is introduced to EDA-PVdF prepared according to the Preparation Example.

### Evaluation Example 2: XPS Analysis

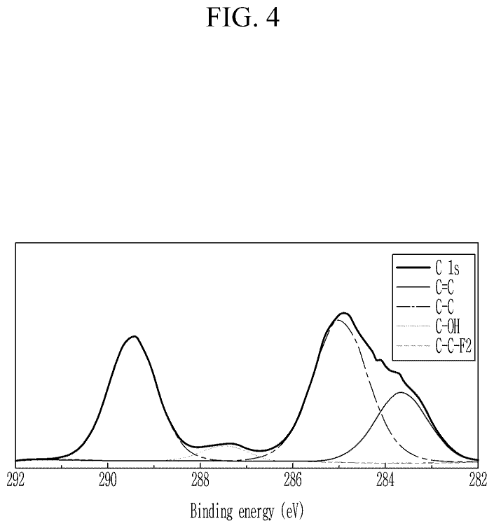

XPS analysis was performed on EDA-PVdF prepared according to Preparation Example 1, and the analysis results are shown in FIG. 4.

Referring to FIG. 4, the area calculation of C—C and C═C signals in the XPS analysis confirms that 32% of the main chain of EDA-PVdF is the double bond.

### Evaluation Example 3: Ion Conductivity Analysis

The gel polymer electrolytes prepared according to the Examples and Comparative examples were each impregnated into a liquid electrolyte for about 24 hours, which was used as an electrolyte layer to assemble a coin cell having a spacer/electrolyte layer/spacer structure. The resistance of the coin cell was measured over a temperature range of 10° C. to 80° C. and converted into lithium-ion conductivity (Zahner Electrik IM6 equipment was used, and frequency range was 100 Hz to 1 MHz at an applied voltage of 10 mV).

The lithium-ion conductivity analysis method is as follows.
a) The amount of liquid electrolyte impregnation is based on 100 parts by weight of gel polymer electrolyte.
b) Measured at 25° C. The liquid electrolyte used is a mixed solvent of ethylene carbonate and dimethyl carbonate.
c) Electrochemical window measured by linear sweep voltammetry

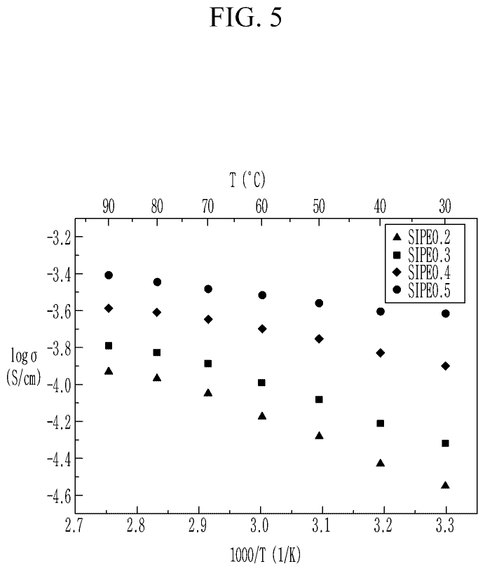

The lithium-ion conductivity analysis results are shown in FIG. 5 and Table 1 below.

TABLE 1

| | | | | Ionic |
|---|---|---|---|---|
| | | | | conductivity |
| | | LiMTFSI | EDA-PVdF | @30° C. |
| | Sample | (wt. %) | (wt. %) | (S cm − 1) |
| Comparative | SIPE 0.2 | 20 | 80 | 2.88 × 10 − 5 |
| Example 1 | | | | |
| Comparative | SIPE 0.3 | 30 | 70 | 4.90 × 10⁻⁵ |
| Example 2 | | | | |
| Embodiment 1 | SIPE 0.4 | 40 | 60 | 1.29 × 10⁻⁴ |
| Embodiment 2 | SIPE 0.5 | 50 | 50 | 2.45 × 10⁻⁴ |
| Comparative | SIPE 0.6 | 60 | 40 | — |
| Example 3 | | | | |

Referring to FIG. 5 and Table 1, it can be confirmed that the lithium-ion conductivity tends to increase as the content of lithium salt LiMTFSI increases.

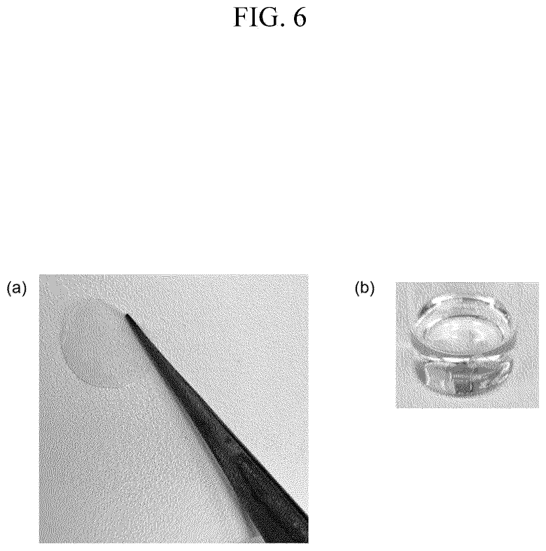

FIG. 6(a) shows a photograph of a gel polymer electrolyte according to Example 2, and FIG. 6(b) shows a result of a crosslinking test.

Referring to FIG. 6(a), it can be confirmed that the gel polymer electrolyte prepared according to Example 2 forms a free-standing shape after separation from the substrate. Referring to FIG. 6(b), it can be confirmed that the gel polymer electrolyte prepared according to Example 2 maintains its shape without dissolving even after being impregnated in the DMF solvent. This is considered to be attributed to the introduction of the crosslinking structure during the preparation process.

On the other hand, in Comparative Example 3 where the content of lithium salt LiMTFSI was 60 wt %, the membrane exhibited a low degree of crosslinking and low elasticity due to the insufficient amount of PVDF. As a result, the membrane was damaged during separation from the substrate, making it impossible to prepare the gel polymer electrolyte and to measure lithium-ion conductivity.

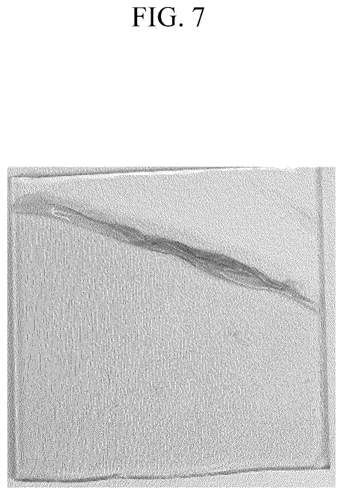

FIG. 7 is a photograph showing that a gel polymer electrolyte according to Comparative Example 3 is not separated from a substrate.

### Experimental Example

The electrolyte layer structure was implemented using a commercially available membrane layer. A lithium metal battery having a Li/electrolyte layer/NCM (NCM900505) structure of a Comparative Example was prepared, and a lithium metal battery having a Li/gel polymer electrolyte layer/electrolyte layer/NCM (NCM900505) structure of an Example was prepared.

In this case, the gel polymer electrolyte layer in the lithium metal battery of the Example was composed of the gel polymer electrolyte according to Example 2.

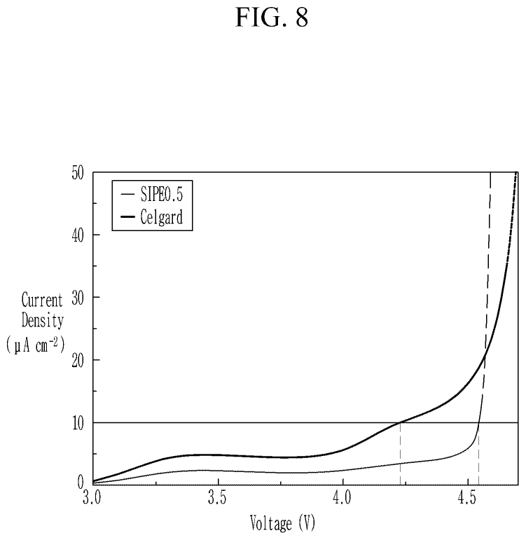

FIG. 8 shows high-voltage stability measurement results at 4.55 V for a lithium metal battery of a Comparative Example and a lithium metal battery of an Example.

Referring to FIG. 8, it can be confirmed that the high-voltage stability is superior in the lithium metal battery of the Example including the layer composed of the gel polymer electrolyte according to Example 2 of the present disclosure.

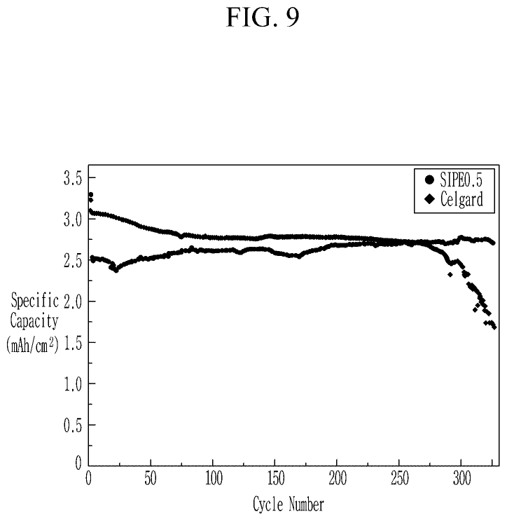

FIG. 9 shows cycle life characteristic analysis results for a lithium metal battery of a Comparative Example and a lithium metal battery of an Example.

It can be confirmed that the lithium metal battery of the Example according to the present disclosure exhibits a stable cycling life of 300 cycles or more at ⅓ C-rate at the positive electrode of NCM900505 at 4.0 mAh·cm⁻² with a driving voltage of 3.0 to 4.3V, demonstrating superior performance compared to the lithium metal battery of the Comparative Example.

While the present disclosure has been described in connection with what is presently considered to be practical exemplary embodiments, it is to be understood that the disclosure is not limited to the disclosed exemplary embodiments. On the contrary, it is intended to cover various modifications and equivalent arrangements included within the spirit and scope of the appended claims.

Therefore, it should be noted that the practical scope of the present disclosure is defined by the appended claims and equivalents thereof.

What is claimed is:

1. A gel polymer electrolyte being a single-ion conducting gel polymer electrolyte, comprising:
a fluorine-based compound with a carbon double bond; and
a lithium salt.

2. The gel polymer electrolyte of claim 1 wherein the carbon double bond is a carbon-carbon double bond.

3. The gel polymer electrolyte of claim 1, wherein:
the lithium salt is included in an amount of about 35 wt % to 55 wt % based on a total weight of the fluorine-based compound with carbon double bond and the lithium salt.

4. The gel polymer electrolyte of claim 1, wherein:
about 30% to 35% of a main chain of the fluorine-based compound with carbon double bond is a double bond.

5. The gel polymer electrolyte of claim 1, wherein:
the lithium salt is one or more selected from the group consisting of lithium 1-(3-(methacryloyloxy) propylsulfonyl)-1-(trifluoromethanesulfonyl)imide (LiMTFSI), lithium (4-styrenesulfonyl) (trifluoromethanesulfonyl)imide (LiSTFSI), lithium methacrylic acid, and lithium 3-(2-methylprop-2-enoyloxy) propane-1-sulfonate.

6. The gel polymer electrolyte of claim 1, wherein:
the fluorine-based compound is one or more selected from the group consisting of polyvinylidene fluoride (PVDF), polyvinylidene fluoride-hexafluoropropylene (PVDF-HFP), polyvinylidene fluoride-co-chlorotrifluoroethylene (PVDF-CTFE), polyvinylidene fluoride-co-trifluoroethylene (PVDF-TrFE), polyvinylidene fluoride-co-trifluoroethylene-co-chlorofluoroethylene, polyvinylidene fluoride-co-hexafluoroethyelene, and polyvinylidene fluoride-co-hexafluoroethyelene.

7. The gel polymer electrolyte of claim 1, wherein:
the gel polymer electrolyte further comprises an additive composed of poly(ethylene glycol)methyl ether methacrylate (PEGMEMA).

8. The gel polymer electrolyte of claim 7, wherein:
the additive is included in an amount of about 10 wt % to 40 wt % based on a total weight of the fluorine-based compound with carbon double bond and the lithium salt.

9. The gel polymer electrolyte of claim 1, wherein:
the gel polymer electrolyte further comprises an impregnated liquid electrolyte.

10. A method for manufacturing a gel polymer electrolyte, the method comprising:
providing a mixture by mixing a fluorine-based compound with a carbon double bond, a lithium salt, and a radical initiator; and
applying the mixture to a base material, and thereafter
crosslinking the mixture,
wherein the lithium salt is added in an amount of about 35 wt % to 55 wt % based on a total weight of the fluorine-based compound, the lithium salt, and a crosslinking agent.

11. The method of claim 10, wherein:
the fluorine-based compound with a carbon double bond is obtained
by mixing a fluorine-based compound and a basic substance to form a fluorine-based compound with a carbon double bond.

12. The method of claim 11, wherein:
the basic substance is one or more selected from the group consisting of ethylenediamine (EDA), isopropylethylenediamine (IEDA), 1,3 phenylenediamine (PDA), 1,5-naphthalenediamine (NDA), 2,4,4-trimethyl-1 or 6-hexanediamine (THDA), dicumyl peroxide (DCP), benzoyl peroxide, bisphenol A, and methylenediamine.

13. The method of claim 11, wherein:
the fluorine-based compound is one or more selected from the group consisting of polyvinylidene fluoride (PVDF), polyvinylchloride (PVC), polymethyl methacrylate (PMMA), polyacrylonitrile (PAN), and polyvinylidene fluoride-hexafluoropropylene (PVDF-HFP).

14. The method of claim 11, wherein:
the mixing the fluorine-based compound and the basic substance to form a fluorine-based compound with an introduced carbon double bond includes:
stirring the fluorine-based compound and the basic substance at a room temperature for about 60 hours or longer.

15. The method of claim 10, wherein:
the lithium salt is one or more selected from the group consisting of lithium 1-(3-(methacryloyloxy) propylsulfonyl)-1-(trifluoromethanesulfonyl)imide (LiMTFSI), lithium (4-styrenesulfonyl) (trifluoromethanesulfonyl)imide (LiSTFSI), lithium methacrylic acid, and lithium 3-(2-methylprop-2-enoyloxy) propane-1-sulfonate.

16. The method of claim 10, wherein:
in the providing the mixture by mixing the fluorine-based compound with an introduced carbon double bond, the lithium salt, and the radical initiator,
an additive composed of poly(ethylene glycol)methyl ether methacrylate (PEGMEMA) is further mixed.

17. The method of claim 16, wherein:
the additive is mixed in an amount of about 10 wt % to 40 wt % based on a total weight of the fluorine-based compound with a carbon double bond and the lithium salt.

18. A lithium secondary battery comprising:
a positive electrode layer;
a negative electrode layer; and
an electrolyte layer positioned between the positive electrode layer and the negative electrode layer,
wherein the electrolyte layer comprises a gel polymer electrolyte layer, and
wherein the gel polymer electrolyte layer comprises the gel polymer electrolyte of claim 1.

19. A gel polymer electrolyte being a single-ion conducting gel polymer electrolyte, comprising:
a fluorine-based compound with an introduced carbon double bond selected from the group consisting of polyvinylidene fluoride (PVDF), polyvinylidene fluoride-hexafluoropropylene (PVDF-HFP), polyvinylidene fluoride-co-chlorotrifluoroethylene (PVDF-CTFE), polyvinylidene fluoride-co-trifluoroethylene (PVDF-TrFE), polyvinylidene fluoride-co-trifluoroethylene-co-chlorofluoroethylene, polyvinylidene fluoride-co-hexafluoroethyelene, polyvinylidene fluoride-co-hexafluoroethyelene, and a combination thereof; and
a lithium salt selected from the group consisting of lithium 1-(3-(methacryloyloxy) propylsulfonyl)-1-(trifluoromethanesulfonyl)imide (LiMTFSI), lithium (4-styrenesulfonyl) (trifluoromethanesulfonyl)imide (LiSTFSI), lithium methacrylic acid, and lithium 3-(2-methylprop-2-enoyloxy) propane-1-sulfonate, and a combination thereof,
wherein about 25% to 40% of a main chain of the fluorine-based compound with a carbon double bond is a double bond, and
wherein the lithium salt is present in an amount of about 35 wt % to about 55 wt % based on a total weight of the fluorine-based compound and the lithium salt.

20. The gel polymer electrolyte of claim 19, wherein:
the gel polymer electrolyte further comprises an additive composed of poly(ethylene glycol)methyl ether methacrylate (PEGMEMA).
